(19) United States
(12) Patent Application Publication
(10) Pub. No.: US 2006/0236345 A1
(43) Pub. Date: Oct. 19, 2006

(54) Video system for a vehicle

(75) Inventor: George C. Schedivy, Aquebogue, NY (US)

Correspondence Address: F. CHAU & ASSOCIATES, LLC, 130 WOODBURY ROAD, WOODBURY, NY, 11797, US

(73) Assignee: AUDIOVOX CORPORATION

(21) Appl. No.: 11/108,960

(22) Filed: Apr. 19, 2005

(51) Int. Cl. H04N 7/18

(52) U.S. Cl. 725/75; 725/77

(57) ABSTRACT

A video system for a vehicle comprises a receiving unit for connecting with a portable hard drive, the receiving unit being disposed in a vehicle and electrically connected to a display, wherein the hard drive is capable of receiving and storing data from a data source. The receiving unit may include a card reader for reading a memory card.

### TECHNICAL FIELD

The present disclosure relates to a video system for a vehicle, and more particularly, to a video system for a vehicle operating with a data storage device.

### DISCUSSION OF RELATED ART

Media equipment designed to play movies from, for example, digital video disks (DVDs), video compact disks (VCDs) and video cassettes recorder (VCR) tapes is becoming more compact as technology advances. This decrease in size has increased the portability of movie players, leading to their integration into vehicles. A system to play movies in the vehicles consists of a monitor receiving media data from a DVD, a VCD, a VCR, or a game system capable of playing DVDs.

However, the size of DVDs, VCDs, and VCR tapes is standardized such that reducing the size of the movie players receiving those data storage devices is limited. Furthermore, the DVDs, VCDs and VCR tapes have limited data storing capacities. Thus, increasing desires of passengers wanting more diverse activities in the vehicles cannot be satisfied with such media storage devices as DVDs, VCDs and VCR tapes. For example, digital cameras and camcorders are widely available, and users want the capability to see media from these devices in their vehicle. Also, business people spending time in a vehicle preparing a business presentation want to view the presentation while riding in the vehicle, and children want to play video games in the vehicle without carrying videogame systems or multiple game DVDs from home.

Therefore, a need exists for a large capacity data storage device with a minimum size that is capable of providing media data to monitors in a vehicle, and capable of downloading and storing media data from a media source.

### SUMMARY OF THE INVENTION

In an embodiment of the present invention, a video system for a vehicle comprises a receiving unit for connecting with a portable hard drive, the receiving unit being disposed in a vehicle and electrically connected to a display, wherein the portable hard drive is capable of receiving and storing data from a data source.

In another embodiment of the present invention, a video system for a vehicle comprises a display, and a receiving unit, electrically coupled to the display, for connecting with a portable hard drive, wherein the portable hard drive is capable of receiving and storing data from a data source, and the display and the receiving unit are disposed substantially in a seat of the vehicle.

In still another embodiment of the present invention, a video system for a vehicle comprises a display, and a receiving unit, electrically coupled to the display, for connecting with a portable hard drive, wherein the portable hard drive is capable of receiving and storing data from a data source, and the display and receiving unit are positioned overhead in the vehicle.

In another embodiment of the present invention, a video system for a vehicle comprises a receiving unit including a card reader for reading a memory card, the receiving unit being disposed in the vehicle and electrically connected to a display.

These and other exemplary embodiments, aspects, features and advantages of the present invention will become apparent from the following detailed description of exemplary embodiments, which is to be read in connection with the accompanying drawings.

### BRIEF DESCRIPTION OF THE DRAWINGS

FIG. 1 shows a video system for a vehicle including a video unit and displays according to an exemplary embodiment of the present invention.

FIGS. 2A, 2B and 2C show a video system for a headrest of a vehicle including the video unit electrically coupled to the display according to an exemplary embodiment of the present invention.

FIG. 3 shows the display and the video unit disposed substantially in an overhead console of the vehicle according to an exemplary embodiment of the present invention.

FIG. 4 shows the display and the video unit disposed substantially in a dash board console of the vehicle according to an exemplary embodiment of the present invention.

FIG. 5 shows a housing including the video unit and a housing including the media player disposed in two headrests of the vehicle.

### DETAILED DESCRIPTION OF PREFERRED EMBODIMENTS

Exemplary embodiments of the present invention will now be described more fully hereinafter below with reference to the accompanying drawings. This invention may, however, be embodied in different forms and should not be construed as limited to the exemplary embodiments set forth herein. Rather, these exemplary embodiments are provided so that this disclosure will be through and complete, and will fully convey the scope of the invention to those skilled in the art.

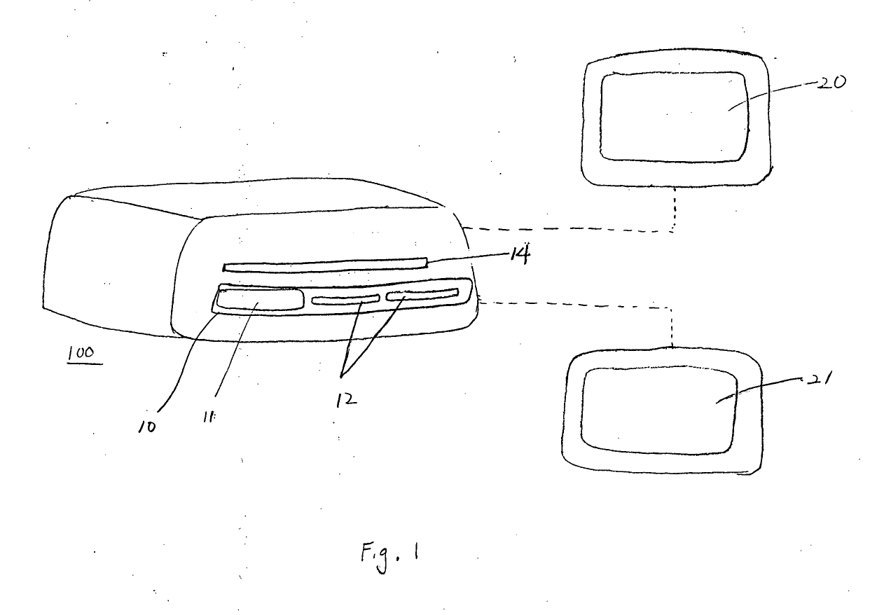

Referring to FIG. 1, a video system for a vehicle includes a video unit 100 and displays 20 and 21 according to an exemplary embodiment of the present invention. The video unit 100 for displaying movies, games or music is disposed in a vehicle and electrically connected to the displays 20 and 21. The electrical connection between the video unit 100 and the displays 20 and 21 can be a wired or a wireless (e.g., infrared or radio frequency) connection. The video unit 100 can be positioned in the interior of the vehicle, such as, in a dash board, under a seat, overhead attached to a vehicle ceiling, mounted to a vehicle seat, in a storage compartment of the vehicle, or another appropriate location in the vehicle. Similarly, the displays 20 and 21 can be disposed in a dash board console, an overhead console, a center console, a headrest, a backrest or other appropriate locations of the vehicle. The displays 20 and 21 preferably include a liquid crystal display (LCD), but may be gas plasma, cathode-ray-tube or electro-luminescent displays. More or less than two displays may be used with the video unit 100.

The video unit 100 includes a receiving unit 10, which is capable of receiving data from a portable data storage device. For example, the receiving unit 10 includes slots or ports 11, 12 for selectively receiving a hard drive, memory cards, a digital video recorder (DVR), flash memory sticks, key drives, thumb drives or other type of portable storage device. The receiving unit 10 can be compatible with configurations such as Small Computer System Interface (SCSI), Universal Serial Bus (USB), Parallel Port, internal AT Attachment (ATAPI), Integrated Drive Electronics (IDE), PCI (Peripheral Component Inter Connect), and the like. The ports may be, for example, USB type ports and the ports and slots include contacts for mating with corresponding contacts on the data storage device or contacts on connectors (e.g., wires or cables) coupled to the data storage device. It is to be understood that the slots and ports may be any type of standardized connection for receiving a data storage device. The data storage device can be directly connected to the receiving unit 10 such that the data storage device is mounted to or in the receiving unit 10. Alternatively, the data storage device can be connected to the receiving unit using a wire or cable (e.g., a USB cable) or via a wireless connection (e.g., infrared, radio frequency, BLUETOOTH or 802.11).

The video unit 100 preferably includes the requisite hardware, software or firmware, including a processor, for reading, formatting, extracting, playing, storing or otherwise controlling the data from the data storage device. The video unit 100 may include a reader capable of supporting one or more memory card interfaces, including, but not limited to, MEMORY STICK, IBM Microdrive, compact flash, smart media, secure digital and multimedia cards. In addition or alternatively, the data storage device can include devices for performing the function of transferring data to the video unit 100 for storage and playing of media associated with the data.

The video unit 100 is configured so that data on the data storage device can be processed for displaying on the displays 20, 21 so that a user may view or listen to a media file, such as a movie, video game or presentation. The data storage device is capable of receiving and storing data from a data source. For example, the data storage device can download and store photos, videogames, movies or music from a personal computer, DVR or a videogame system (e.g., SONY PLAYSTATION®). Also, the data storage device can download and store images, video and sound from devices such as digital cameras, camcorders, cellular telephones, personal digital assistants (PDAs) and MP3 applications. Photos or videos can be uploaded from the data storage device to the video unit 100 and displayed on the displays 20 and/or 21. The data storage device has, for example, 20-gigabytes (GB) capacity but may have more or less capacity.

In another embodiment of the present invention, the data can be downloaded to the data storage device from a satellite. Also, the data can be downloaded to the data storage device using a wireless system, for example, a wireless port, such as an infrared (IR) port, from a wireless router. The video unit 100 further comprises a media player 14, electrically coupled to the displays 20 and 21, for playing media stored on a data storage medium such as a DVD, a CD or a videocassette.

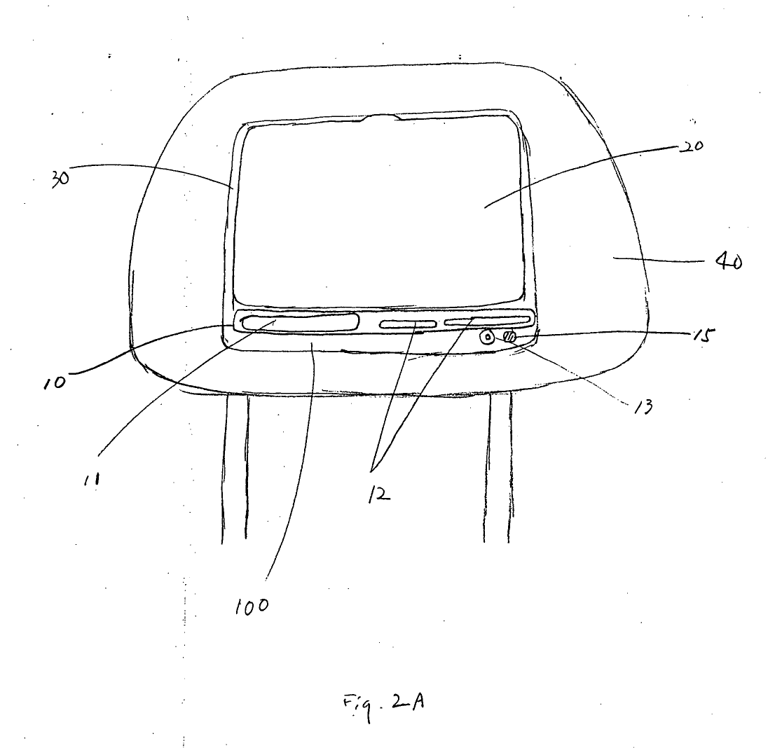

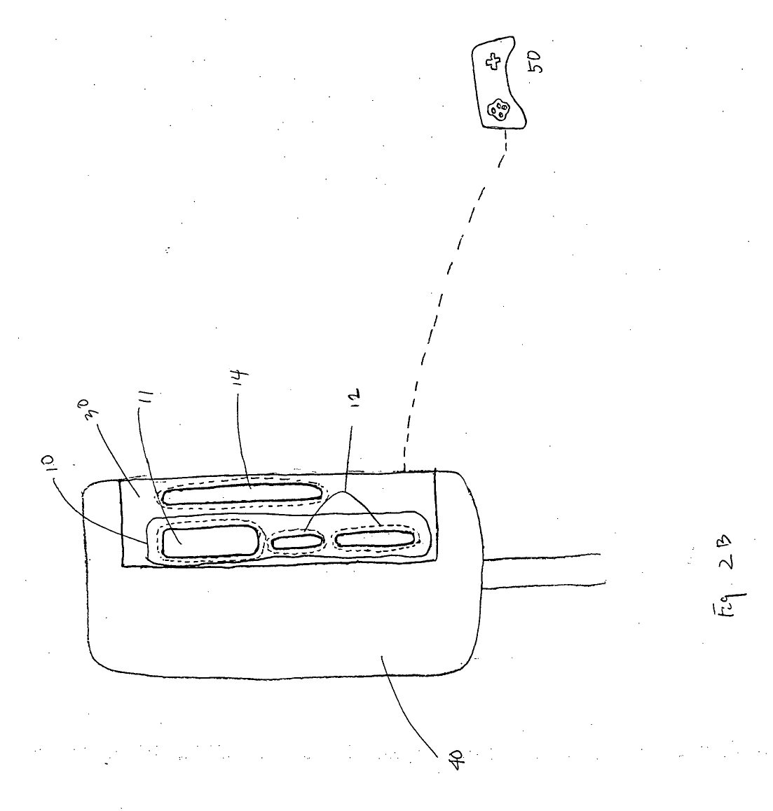

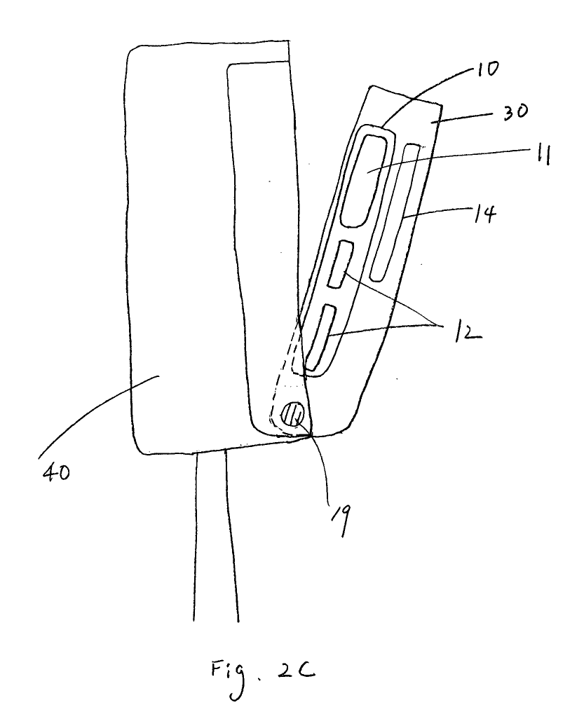

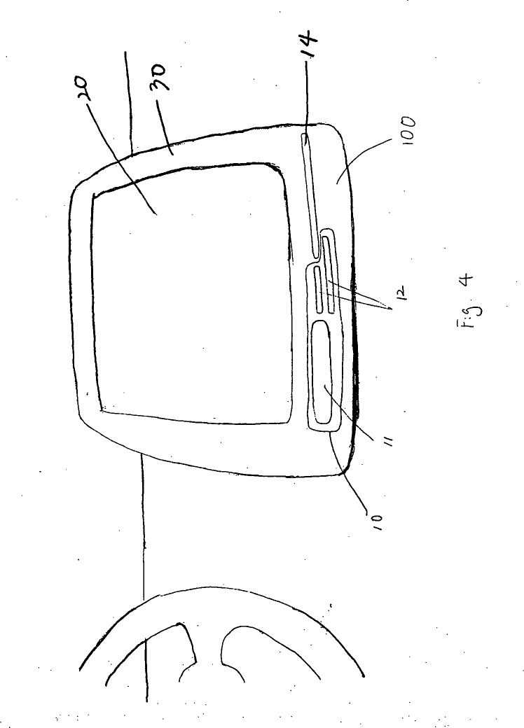

Referring to FIGS. 2A and 2B, a video system for a vehicle includes the video unit 100 electrically coupled to the display 20 according to an exemplary embodiment of the present invention. As shown in FIG. 2A and FIG. 4, the video unit 100 can be physically combined with the display 20 in a housing 30. As shown in FIG. 2A, the housing 30 can be disposed substantially in a headrest 40. The housing 30 can be fixedly disposed in the headrest 40. Alternatively, the housing 30 can be removably disposed in the headrest 40 so that he housing is easily removed from the headrest 40, using for example, a quick release mechanism, such as a spring loaded locking device. When the housing 30 including the video unit 100 and the display 20 is removably attached to the headrest 40, users can enjoy the video system outside of the vehicles.

The video unit 100 further includes a controller port 13 for receiving a controller 50 of a video game. Alternatively, the controller 50 of a video game can be wirelessly connected to the video unit 100 using a remote control sensor 15, that is, for example, infrared (IR). Thus, users can play video games with a wireless controller while watching the display 20 disposed in the headrest 40. Video games requiring increased memory can be stored on the data storage device.

The video unit 100 further includes the media player 14. The video unit 100 can be disposed on a side, top, bottom or front of the housing 30. For example, slots 11 or ports 12 are disposed on the front of the housing 30 so that data storage device(s) may be inserted in, connected to or removed from the video unit 100. Alternatively, the video unit 100 can be disposed on a side of the housing 30 as shown in FIG. 2B, and headrest openings (shown as disconnected lines) align with slots and ports 11, 12 of the receiving unit 10 and the media player 14, thereby enabling connections from the side. Alternatively, as shown in FIG. 2C, the housing 30 can be pivoted away using, for example, a hinge system 19 from the headrest 40 to expose the slots or ports for receiving the data storage device(s) and the media player for receiving, for example, DVDs.

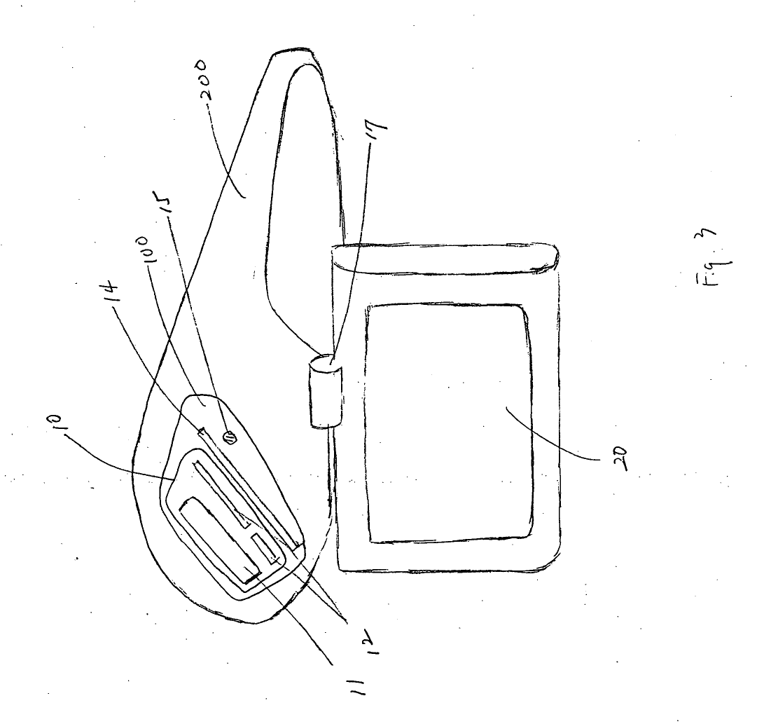

Referring to FIG. 3, the display 20 and the video unit 100 are disposed substantially in an overhead console 200 of the vehicle according to an embodiment of the present invention. A flip-down style display 20 is electrically connected to the receiving unit 10 and the media player 14, which are disposed in the overhead console 200. The flip-down style display 20 can be rotated using a hinge system 17. Viewers can select and play movies, video games, and view photos and business presentation files stored on the data storage device. A remote controller (not shown) for controlling the media (e.g., such functions as play, pause, stop, fast-forward and rewind) may be used with the remote control sensor 15.

Referring to FIG. 4, the display 20 and the video unit 100 are disposed substantially in a dash board console of the vehicle according to an embodiment of the present invention. In this embodiment, front seat occupants can watch movies, play video games and listen to music stored on the data storage device(s).

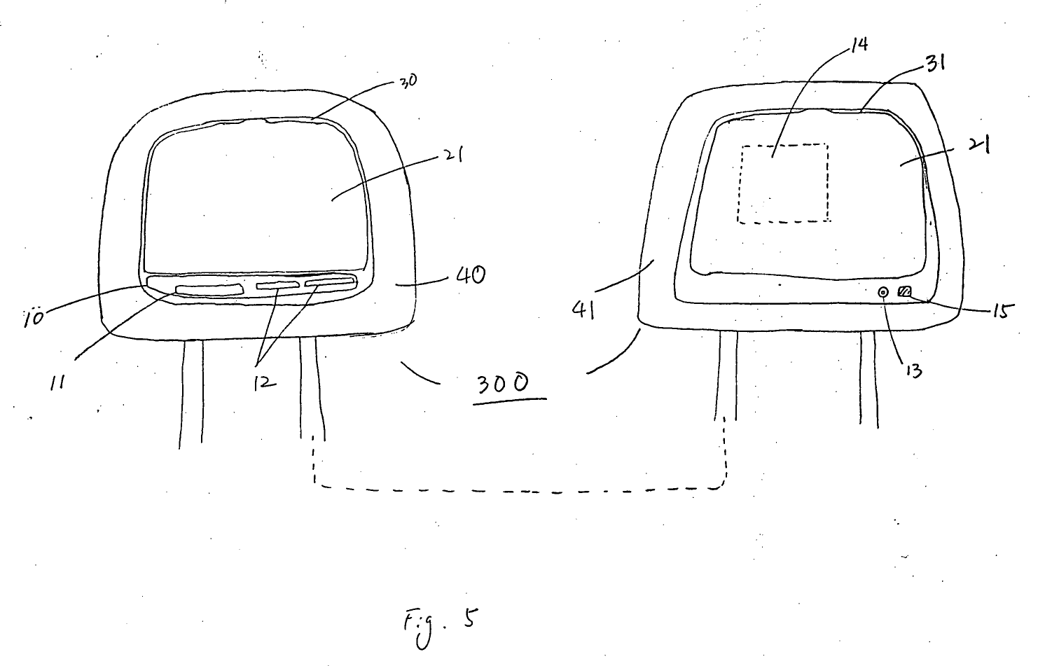

Referring to FIG. 5, a video unit 300 is shown, wherein the housing 30 including the receiving unit 10 is disposed substantially in a headrest 40, and a housing 31 including the media player 14 is disposed substantially in a headrest 41 of the vehicle. The data storage device(s) connect with the receiving unit 10 as previously described via, for example, slots 11 and ports 12 disposed in the headrest 40. A DVD can be inserted in the media player 14 disposed in the headrest 41. Thus, the display 20 can receive media data from data storage device(s), and the display 21 can receive media data from a data storage medium such as the DVD. As a result, one can watch movies on the screen 21 while another plays video games on the screen 20 or vice versa. Alternatively, media from the data storage device(s) or the data storage medium for the media player 14 can be shared between the headrest 40 and the headrest 41. Thus, passengers can play video games together, or watch the same movie displayed on each of the screens 20 and 21.

According to embodiments of the present invention, the video units 100, 300 can be disposed in various vehicles including automobiles, buses, air craft and boats. Further, the video units 100, 300 may be used outside the vehicle environment, such as in the home or office. Also, users can control the functions of the video system using, for example, a remote controller, a touch screen system or pushing buttons disposed on the video units 100, 300.

Although exemplary embodiments have been described herein with reference to the accompanying drawings, it is to be understood that the present invention is not limited to such exemplary embodiments, and that various other changes and modifications may be affected therein by one of ordinary skill in the related art without departing from the scope or spirit of the invention. All such changes and modifications are intended to be included within the scope of the invention as defined by the appended claims.

What is claimed is:

1. A video system for a vehicle, comprising:
a receiving unit for connecting with a portable hard drive, the receiving unit being disposed in the vehicle and electrically connected to a display, wherein the hard drive is capable of receiving and storing data from a data source.

2. The video system of claim 1, wherein the receiving unit includes a card reader for reading a memory card.

3. The video system of claim 1, wherein the receiving unit is connectable to a portable flash memory device.

4. The video system of claim 1, wherein the receiving unit is connectable to a portable digital video recorder.

5. The video system of claim 1, wherein the hard drive stores data for at least one of photos, videogames, movies and music.

6. The video system of claim 1, wherein the data source includes a personal computer.

7. The video system of claim 1, wherein the data source includes a cellular phone.

8. The video system of claim 1, wherein the data source includes a personal digital assistant.

9. The video system of claim 1, wherein the data source includes a digital video recorder.

10. The video system of claim 1, wherein the data source includes a video game system.

11. The video system of claim 1, further comprising a processor for controlling data received from the hard drive.

12. The video system of claim 1, further comprising a media player, electrically coupled to the display, for playing media stored on a data storage medium.

13. The video system of claim 12, wherein the data storage medium includes at least one of a digital video disk, a compact disk and a videocassette.

14. The video system of claim 1, further comprising a controller port for receiving a controller of a videogame.

15. The video system of claim 1, wherein the receiving unit is disposed in a dash board of the vehicle.

16. The video system of claim 1, wherein the receiving unit is disposed under a seat of the vehicle.

17. The video system of claim 1, wherein the receiving unit is disposed in a seat of the vehicle.

18. The video system of claim 1, wherein the receiving unit is positioned overhead in the vehicle.

19. The video system of claim 1, wherein the display is positioned on at least one of a seat, a dash board, a center console and an overhead portion of the vehicle.

20. The video system of claim 1, wherein the display includes at least one of a liquid crystal display, a gas plasma display, electro-luminescent display or a cathode-ray tube display.

21. A video system for a vehicle, comprising:
a display; and
a receiving unit, electrically coupled to the display, for connecting with a portable hard drive, wherein the portable hard drive is capable of receiving and storing data from a data source, and the display and the receiving unit are disposed substantially in a seat of the vehicle.

22. The video system of claim 21, wherein the receiving unit includes a card reader for reading a memory card.

23. The video system of claim 21, wherein the receiving unit is connectable to a portable flash memory device.

24. The video system of claim 21, wherein the receiving unit is connectable to a portable digital video recorder.

25. The video system of claim 21, further comprising a processor for controlling data received from the hard drive.

26. The video system of claim 21, further comprising a media player, electrically coupled to the display, for playing media stored on a data storage medium.

27. The video system of claim 26, the data storage medium includes at least one of a digital video disk, a compact disk and a videocassette.

28. The video system of claim 26, wherein the receiving unit and the media player are disposed in two different seats.

29. The video system of claim 28, further comprising a second display disposed in the same seat as the media player, the second display being electrically coupled to both the receiving unit and the media player.

30. The video system of claim 21, further comprising a second display disposed in a second seat of the vehicle, wherein the second display is electrically coupled to the receiving unit.

31. A video system for a vehicle, comprising:
a display; and
a receiving unit, electrically coupled to the display, for connecting with a portable hard drive, wherein the hard drive is capable of receiving and storing data from a data source, and the display and receiving unit are positioned overhead in the vehicle.

32. A video system for a vehicle, comprising:
a receiving unit including a card reader for reading a memory card, the receiving unit being disposed in the vehicle and electrically connected to a display.

33. The video system of claim 32, wherein the receiving unit is connectable to a portable hard drive.
